(19) United States
(12) Patent Application Publication
(10) Pub. No.: US 2005/0202386 A1
(43) Pub. Date: Sep. 15, 2005

(54) Flip-over storytelling book publishing system, method, and kit

(76) Inventor: Jehan Clements, Tarrytown, NY (US)

Correspondence Address: MILBANK, TWEED, HADLEY & MCCLOY LLP, 1 CHASE MANHATTAN PLAZA, NEW YORK, NY, 10005-1413, US

(21) Appl. No.: 10/801,401

(22) Filed: Mar. 15, 2004

(51) Int. Cl. G09B 19/00

(52) U.S. Cl. 434/317; 434/307 R

(57) ABSTRACT

A system and method for producing a flip-over storytelling book having a first set of pages in diametric contraposition to a second set of pages includes a software program for generating the first and second sets of pages from user input. A kit for producing such books includes a software program and a blank book (composed of a front cover, a back cover, a binding, blank leaves, and/or pocket-leaves) for insertion of the pages generated by using the software program. The generated pages may include indicia indicating the sequence and orientation of the first and second sets of pages.

### BACKGROUND OF THE INVENTION

It is known to prepare a flip-over storytelling book by arranging pages in a book-like fashion and bound together so that the book may be disposed either with the pages flat on a support or having the binding at the top in an easel-like disposition.

In such books having, for example, sequentially-numbered pages, the first even-numbered page of the first leaf within the book carries an illustration of a portion of a story, with each successive even-numbered page of successive leaves carrying another illustration of another portion of the story, so that the even-numbered pages, taken as a set, illustrate substantially the entire story. The next consecutive odd-numbered page of each leaf within the book carries a copy of the same illustration that appears on the adjacent previous even-numbered page, along with textual material for the story correlated to the illustrations on both of the consecutive odd and even-numbered pages. The consecutive odd- and even-numbered pages that correspond to each other, as a set, are disposed in diametric contraposition to each other within the book. An audience listening to the story sees the illustrations on the even-numbered pages, and the storyteller/reader sees the same illustrations and text on the next consecutive odd-numbered pages. These prior-art methods and devices discussed above are described in U.S. Pat. Nos. 5,713,743 and 6,210,172, which are both incorporated by reference herein.

It is also known to create pages for insertion in such books using the “Storybook Weaver” software from The Learning Company of Minneapolis, Minn.

### SUMMARY OF THE INVENTION

A system and method for producing a flip-over storytelling book having a first set of pages in diametric contraposition to a second set of pages includes a software program for generating the first and second sets of pages from user input. A kit for producing such books includes a software program and a blank book (composed of a front cover, a back cover, a binding, blank leaves, and/or pocket-leaves) for insertion of the pages generated by using the software program. The generated pages may include indicia indicating the sequence and orientation of the first and second sets of pages.

### BRIEF DESCRIPTION OF THE DRAWINGS

FIG. 1 shows a cover page screen produced by an embodiment of the invention.

FIG. 2 shows a reverse side of a cover page screen as automatically generated by an embodiment of the invention.

FIG. 3 shows an inside title page screen as automatically generated by an embodiment of the invention.

FIG. 4 shows a blank story screen produced by an embodiment of the invention.

FIG. 5 shows a diametric contraposition screen produced by an embodiment of the invention.

FIG. 6 shows a portion of a flip-over storytelling book in accordance with an embodiment of the invention.

FIG. 7 shows a flow chart of a method of an embodiment of the invention.

### DETAILED DESCRIPTION OF THE DRAWINGS

The computer software program of the present invention provides users, such as students in a school, with a graphical presentation on the computer screen to assist such users in writing and illustrating a story of their own creation in the form of a flip-over diametric contraposition storytelling book. The software program may also be used in a home schooling environment with a personal computer and printer.

As used herein, the term “leaf” refers to a single sheet, of a material such as paper, having two sides. The term “page” refers to the subject matter printed, or to be printed, on one side of a leaf.

To begin, the software program provides a book cover in landscape view for the user to work with. The book cover may be further designed and customized with the use of backgrounds and clip art, so that it relates to the title and subject of the story created by the user.

After the front cover is designed, the software program produces another page in landscape view 10 with the name of the book, the title of the story, and the name of the user. The “Rights” information automatically appears at the bottom of this page, which is the reverse side of the front cover.

The user creates art work using clip art or other graphics, and writes text for the story. An unlimited number of blank story screens is provided by the software program until the story is completed by the user. It is possible for the user to return to the book cover, or any of the subsequent pages, to make changes to the art work and the words as many times as necessary. After the story is completed, the software program presents a slide show of all the pages of the story in succession. The story will be presented on the screen so the user has a more complete view of the story, and evaluate whether further changes are needed. The software program automatically produces and displays on the top side edge of all of the inside pages, information and instructions as to which side edge of the printed pages are to be punched and bound to form a flip-over storytelling book. The software program automatically produces and displays on the screen an additional page, corresponding to each page created by the user, for display to an audience. As an example, pages 2 and 3 of the user's story may be displayed on the screen at the same time to more fully demonstrate their diametric contraposition relationship to each other.

When the final version of the story is completed, the software program may display a tutorial, such as a video presentation, to teach the user how to print out the pages of the story. Using a printer connected to the computer, the user is given instructions how to print both sets of pages corresponding to each side of the leaves of the book. The software program may provide further instructions to the user as to how to punch and bind the front cover, the reverse side of the front cover, as well as the inside leaves, and then bind the blank back cover together with a horizontal binding, such as a spiral binding. The software program automatically orients the pages of the book so that the pages that the audience would see, as well as the pages that the user would read from in the completed book, are displayed in diametric contraposition to each other within the book.

The storytelling book publisher software program provides the user with tools to create an entire flip-over storytelling book. The front cover and all of the inside pages are created page-by-page on the computer screen, without the use of paper, until the user is ready to print out the book. Assuming that the final book is page-numbered sequentially, the user thus creates all of the odd-numbered pages of the story, and the software program automatically produces the even-numbered pages of the story.

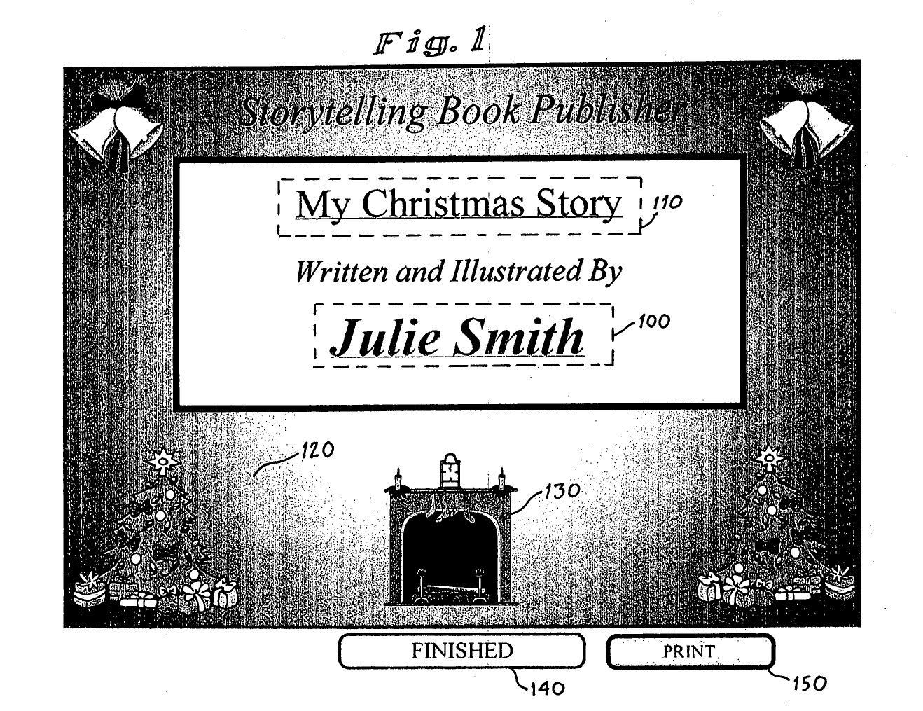

FIGS. 1-5 and the following description outline the steps the user follows using an embodiment of the storytelling book publisher software program of the present invention. In the example described below, the pages in the storytelling book are sequentially numbered. When the user/reader presents the story to an audience, the user reads from pages 3, 5, 7, 9, etc. and the audience will see pages 2, 4, 6, 8, etc. at the same time. Pages 2 and 3, 4 and 5, 6 and 7, 8 and 9, etc. will be oriented in diametric contraposition to each other within the book. In this example, the odd-numbered pages are created by the user, and the even-numbered pages are automatically produced by the software. As long as a second set of pages (which alternate with the user-generated pages in a completed flip-over storytelling book) is automatically generated by the software, it does not matter how, or whether, the pages are numbered.

A cover page, supplied by the storytelling book publisher software program, is illustrated in FIG. 1. On the screen there is a story screen page in the landscape mode with text boxes for the user to type in the user's name 100 and the title 110 of the story. The user may, for example, change the color of the background 120 or paste art 130 onto the cover page that relates to the title and subject of the story.

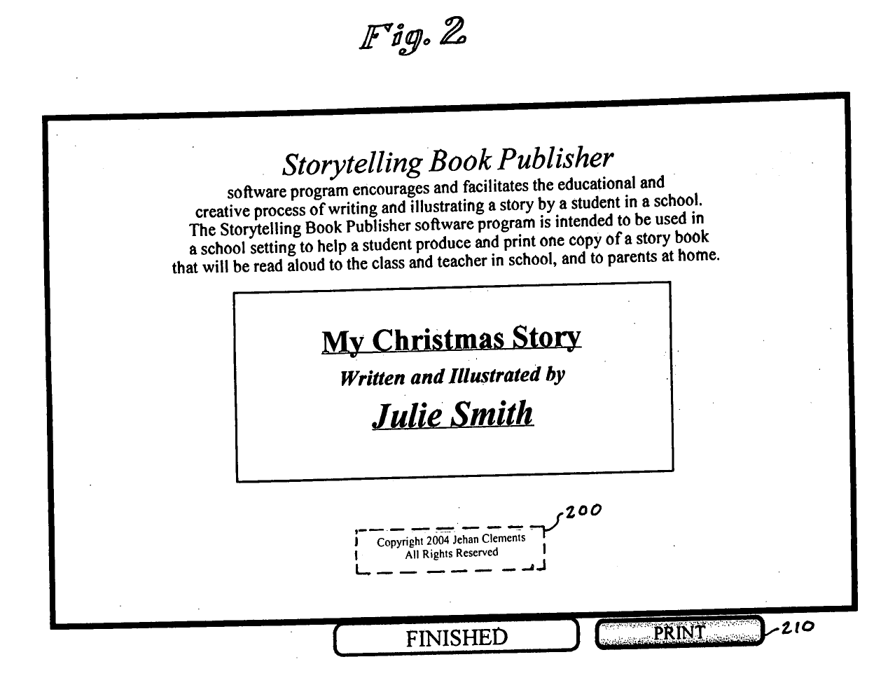

The reverse side of the cover page, illustrated in FIG. 2, is automatically produced by the storytelling book publisher software program when the user clicks on the “Finished” button 140 located at the bottom of the front cover page screen. This page will then be displayed on the screen in landscape mode and will show the name of the book, the name of the user and the title of the story. The “Rights” information 200 may automatically appear at the bottom of the reverse side of the front cover page.

The front cover of the book and the reverse side of the cover may be printed separately from the inside pages. For example, one piece of glossy photo paper is placed into the feeder tray of the printer. By clicking on the “Print” button 150, the printer prints the cover page on the glossy side. By simply turning the page over and placing it back into the feeder tray in the same direction that it came out of the printer, and clicking on the “Print” button 210, the printer prints the back of the cover page on the matte finish side.

The binding edge of the cover and the binding edge of the reverse side of the cover are punched on the same top edge. The software program automatically orients the reverse side of the cover so that it appears right-side-up to the audience when the user reads the book aloud to an audience.

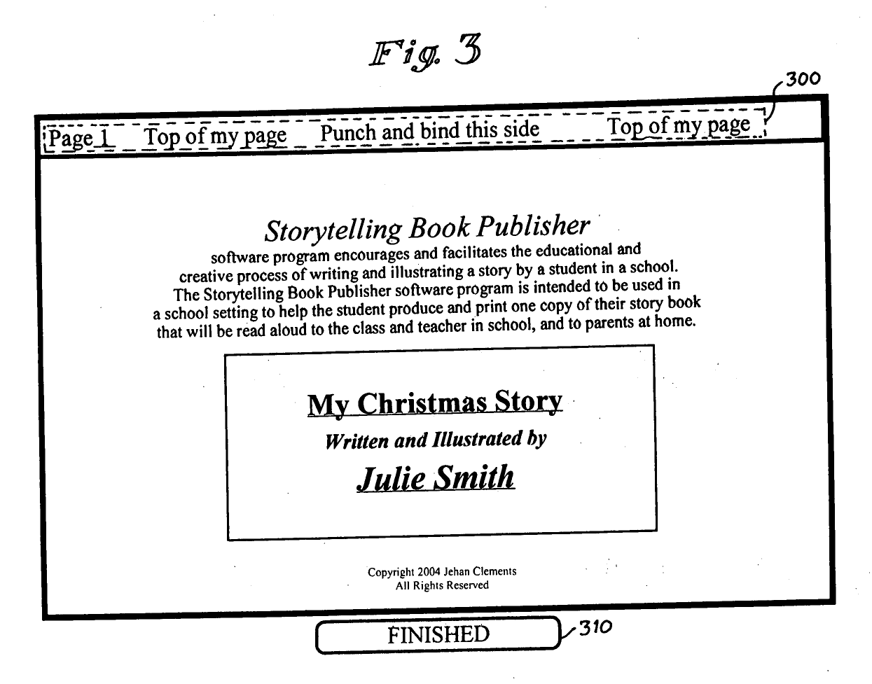

As illustrated in FIG. 3, the software program automatically produces another title page for the book. This page would be “page 1” of the inside pages of the book. This page contains the name of the book, the title of the story, and the name of the user. The software program automatically produces the “Rights” information at the bottom of this page.

As noted in FIG. 3, the software program automatically produces indicia 300, such as page numbers and binding instructions, on page 1 of the book.

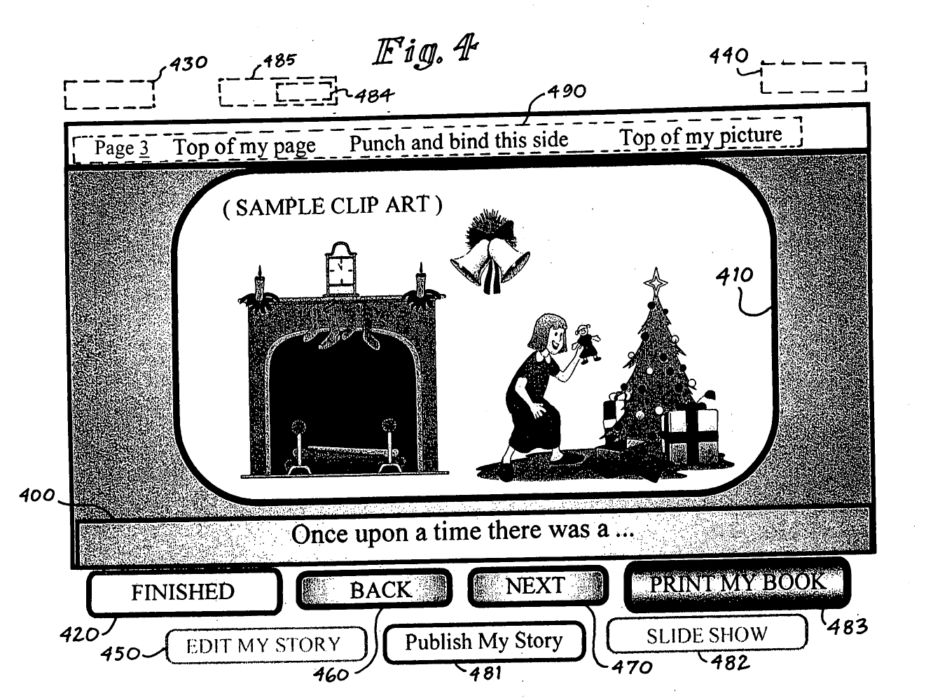

A blank story screen for an odd-numbered page, shown in FIG. 4, will appear when the user clicks on the “Finished” button 310 on the screen at the bottom of the page. The user will begin the story by typing in the text box 400, or begin by pasting art into the picture box 410 displayed within the story screen produced by the software program. The user clicks on the “Finished” button 420 to move to the next step.

The text box provided by the software program contains, or operatively relies on, a word processing program. Using the “Text Format” buttons 430 in the tool bar, the user will be able to format, for example, the font, style, size, color, and justification of the words of the story.

Clip art that the user may use to illustrate the story may be stored within the computer. For example, the clip art may be downloaded as part of the installation of the software program on the computer. The user may have access to different backgrounds to give an environment for the story. The user may paste clip art of objects, plants, animals, and people into the picture box within the story screen to illustrate a portion of the story. As an alternative, the software program may have drawing tool buttons 440 for preparing original artwork for the user's story.

By clicking on the “Finished” button 420, the software program allows the user to move onto the next odd-numbered page in the book. The software program then provides a blank story screen for the next odd-numbered page. The user will continue to create the story, by typing words into the text box 400 and adding art into the picture box 410 of the story screen.

As shown in FIG. 4, the software program automatically produces indicia 490, such as page numbers and binding instructions, on the story pages of the book.

The user continues to write words and create illustrations for the story on the odd-numbered pages, and the software program continues to provide blank story screens until the user is finished with the story. By using the “Edit My Story” 450, “Back” 460, and “Next” 470 buttons, the user is able to navigate through the story, and return to the cover or any of the inside story pages to make as many changes as necessary.

When the user is completely finished with the story, the user may click on the “Publish My Story” 481 or “Slide Show” 482 buttons shown in FIG. 4.

The “Publish My Story” button 481 causes all of the pages to appear on the screen at the same time in thumbnail images.

The “Slide Show” button 482 causes all of the pages to be displayed on the screen one after another. The user will be able to navigate through the pages by using the “Back” 460 and “Next” 470 buttons on the screen.

The “Publish My Story” and “Slide Show” presentations may be played as many times as necessary. This step is designed to provide the user with an overview of the entire story, without interruption, so an extra evaluation may be made. These two features will allow any user to read the story aloud off of the screen, but not make any changes to the illustrations or words.

The “Edit My Story” button 450 may require the use of a password created by the original author/illustrator user. By clicking on the “Edit My Story” button 450, the software program takes the user to the front cover of the book. The user may make changes to the front cover (these changes, if they apply, will automatically be made by the software program to the reverse side of the front cover, and the first inside page of the book) and to any of the relevant inside pages of the book.

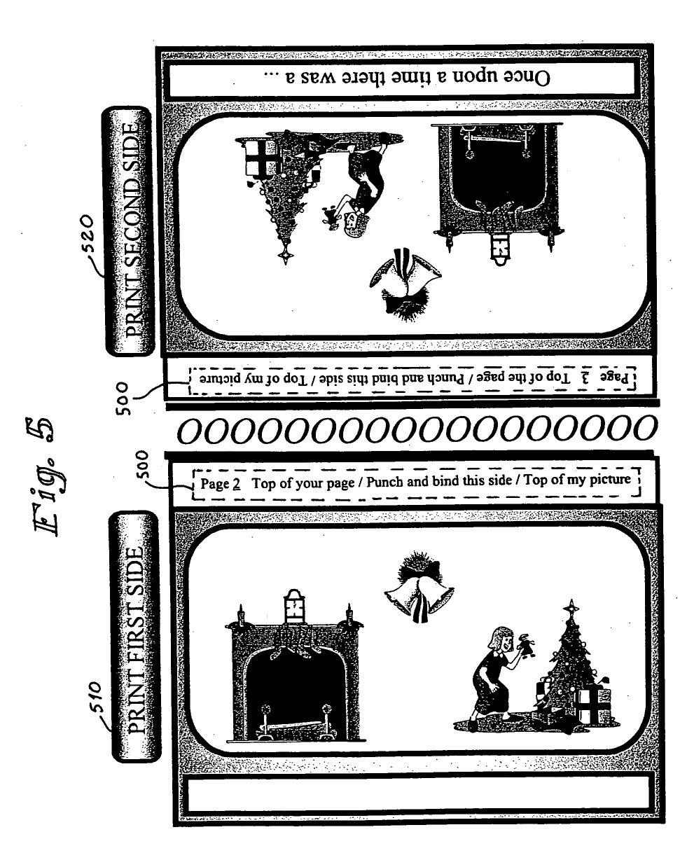

The software program will then display a tutorial, such as a video, to teach the user how the pages of the story will appear in the book. For example, as illustrated to FIG. 5, pages 2 and 3 will appear on the screen at the same time. Page 3 (and all odd-numbered pages) will have been created by the user as part of the input steps described above. Page 2 (and all even-numbered pages) is automatically produced by the software program. The software program displays pages 2 and 3 vertically on the screen in diametric contraposition to each other.

At least two different versions of automatically generated pages may be produced. In a “story reading” version, the software program will automatically produce pages 2, 4, 6, 8, etc. as an exact copy of the corresponding pages 3, 5, 7, 9 etc. These even-numbered pages will contain the same illustrations and words as their corresponding odd-numbered pages. In a “storytelling” version, the software program will automatically produce pages 2, 4, 6, 8, etc. as a copy of the illustrations on corresponding pages 3, 5, 7, 9, etc., but without some or all of the words accompanying the illustrations. In both versions, the even-numbered pages may include an enlarged or enhanced version of the text or images on the odd-numbered pages.

As illustrated in FIG. 5, the software program will automatically produce and display orientation indicia 500, such as page number and binding instructions, on the pages. These indicia 500 will instruct the user as to which side edge of each page is to be punched and bound together, in diametric contraposition to each other. As an example, FIG. 5 illustrates a “storytelling” version in which some or all of the words accompanying the illustrations are omitted on the automatically-generated pages.

For example, and as illustrated in FIG. 5, the instructions for where to punch and bind the top side edge of each page of the story may be automatically printed on the top side edges.

This method will help the user with a first book created by the software. As an alternative, the instructions for where to punch and bind the top side edge of all the pages will appear only on the top side edge of page 1, as all the other pages underneath may be in their correct position and orientation as they come out from the printer. This method may be used after the user becomes familiar with the concept of diametric contraposition.

When the user is ready to print the story, the user will click on the “Print My Book” button 483. Continuing the example numbering scheme described above, stories created with the software program will end with an odd page number. The software program may automatically produce an additional even-numbered page (e.g., with “The End” printed on it), which will be oriented for display to the audience during the reading of the story. This additional even numbered page with “The End” printed on it will give the user, the software program and the printer a point of reference during the process of printing the inside pages of the book.

Once printed, the pages for the reader and the audience will be bound together with a horizontal binding, such as a spiral binding. The cover and inside pages will be in diametric contraposition to each other within the book. The author/illustrator user is now ready to read the flip-over storytelling book aloud to an audience.

The following steps are to be followed if the user is using a printer that prints a single page (i.e., a single side of a leaf) at one time. The software program will display a video to teach the user how to work with the paper and the printer, and how the pictures and words for the story will be printed on both sides of the leaves of paper.

As shown in FIG. 5, when the user clicks on the “Print First Side” button 510, all of the even-numbered pages will be printed out in reverse order. The user will then take all of the pages, and turn them over, and place the pages back in the feeder tray in the same direction that they came out of the printer.

When the user clicks on the “Print Second Side” button 520, all of the odd-numbered pages will be printed out in reverse order. The user will then put the cover on top of the pile of the inside pages that are in their correct order and correct orientation, and take them to the punching and binding machine. The book cover and the inside pages may be punched and then bound together with a pre-punched blank back cover.

For example, one hypothetical story created by the user could be 4 pages long, and will be printed on 8 sides of 5 pieces of paper. Pages 1 and 10 may contain printed matter but will not be story pages, as they would not normally be able to be placed in diametric contraposition to each other in a normal book-type binding. By clicking on the “Print First Side” button 510, the computer printer will print out all the even-numbered inside pages, in reverse order. The printer will print out pages 10, 8, 6, 4, and 2, facing up, with page 10 at the bottom, and page 2 on the top of the pile. The user will then take all 5 leaves, turn them over so the blank side is showing, and then put them back into the feeder tray of the printer facing in the same direction that they came out of the printer. Pages 10 through 2 are now facing down. The blank top side of the leaf facing up at the top of the pile has page 10 on its reverse side. The blank top side of this leaf will become page 9. The blank top side of the leaf at the bottom of the pile of pages has page 2 printed on its reverse side. The blank top side of this bottom leaf will become page 1.

The user then clicks on the “Print Second Side” button 520. All the odd-numbered pages 9, 7, 5, 3, 1, will be printed in reverse order on the blank reverse sides of pages 10, 8, 6, 4, and 2, respectively. The five leaves of the book with pages numbered 1 through 10 will be produced into a pile in correct order, with all the images on the pages in diametric contraposition to each other. The user will put the pre-printed front cover on top of the pile, with the top side edge of the front cover in the same position as the top side edge of all of the inside pages. The front cover and all of the inside pages will be punched along the top side edge. The front cover and inside pages are then bound together along with a pre-punched blank back cover, which may be supplied as part of a kit.

Alternatively, the user's story may be printed on both sides of the leaves as part of a single operation of a printer. By making use of a printer that prints on both sides of the paper at the same time (e.g., by printing one side and then the other before the leaf comes out of the printer), the pages may be automatically printed in diametric contraposition format.

Furthermore, the book may be produced in the portrait mode rather than the landscape mode, but still having all the pages in diametric contraposition to each other.

Also, as shown in FIG. 4, the software program may have a feature to display the orientation of the user's story book pages that will be in diametric contraposition to each other. A “Full View” button feature 484 in a “View” drop down menu 485 in a tool bar on the page screen could show pages 2-3, 4-5, 6-7, 8-9, etc. on the screen at the same time vertically and in diametric contraposition to each other.

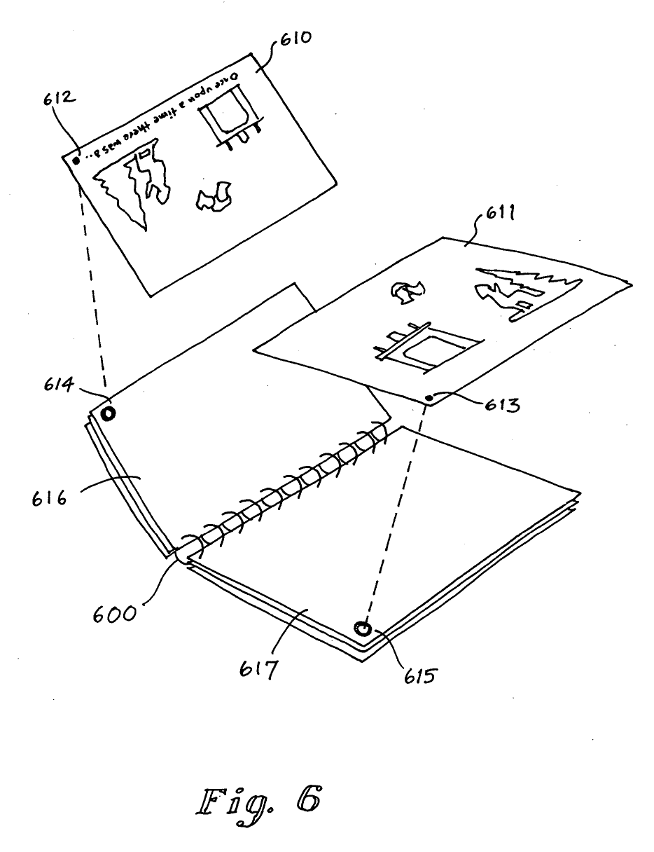

The indicia 500 included on the printed pages are intended to help the user to orient the printed pages of the book into their proper order and in proper diametric contraposition to each other. Accordingly, these indicia 500 may include symbols or written instructions and applied to the printed pages, with the leaves and pages punched and bound between the front and back cover of a blank book 600, or for orienting the printed pages in relationship to corresponding indicia on blank or pocket-leaves that will hold the printed leaves in place between the front and back cover of a book. For example, as illustrated in FIG. 6, the printed pages 610, 611 may include dots 612, 613 printed in an appropriate corner, that would correspond to rings 614, 615 printed on blank book pages 616, 617. This method would allow a user to quickly assemble a storytelling book in diametric contraposition form without the need to read written instructions.

As used herein, the term “pocket-leaves” encompasses, but is not limited to, clear loose-leaf envelopes, clear loose-leaf page holders, clear plastic pocket pages, or other leaves having pockets, sleeves, slits, or envelopes suitable for holding leaves containing printed pages, such as the story pages described above.

As used herein, the term “blank book” encompasses, but is not limited to, a book consisting only of a front and back cover and a binding, or to a book including these elements as well as essentially blank sheets of paper or pocket-leaves, as long as the blank book is suitable for the insertion of leaves containing printed pages on one or both sides. Accordingly, leaves and their printed pages may be inserted into a blank book by, for example, attaching the printed leaves to a binding, placing the leaves into a blank book in which the bound leaves are pocket-leaves leaves suitable for receiving the printed leaves, or affixing the printed leaves to a blank book in which the bound leaves are essentially blank sheets suitable for affixing the printed leaves.

An embodiment of the software program described above and a blank book for inserting pages in diametric contraposition may be provided as a kit. A user may produce flip-over storybook pages using the software program described above and then insert them into a blank book supplied as part of the kit.

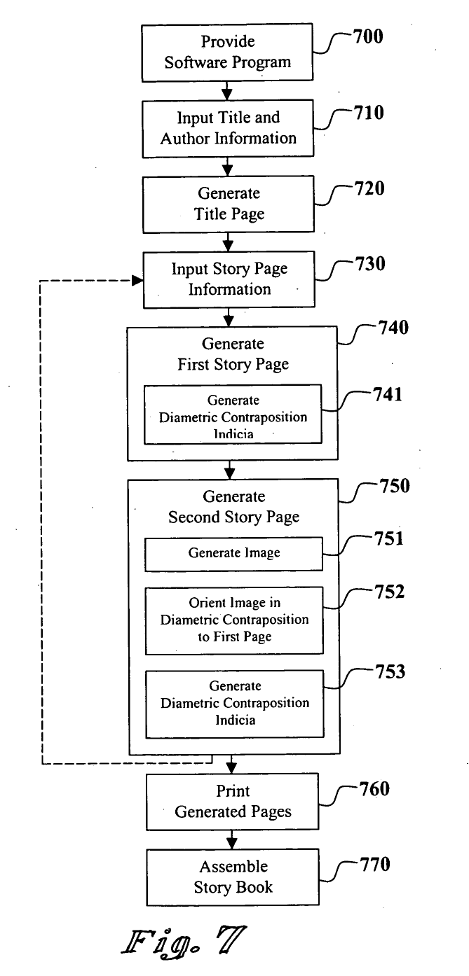

FIG. 7 illustrates the method of producing flip-over storybook pages in accordance with a software program embodiment of the present invention. A software program is provided for producing a flip-over storytelling book (step 700). The user inputs author and title information (step 710). The software program generates at least one title page from the previously input information (step 720). The user inputs story page information for at least one first story page (step 730). The software program generates at least one corresponding first story page (step 740) which may include generating indicia for indicating the position of the story page in a sequence of pages as well as its orientation to the binding of the storybook for placing the first story page in diametric contraposition to a second story page (step 741). The software program generates at least one second story page (step 750), which includes the steps of generating the images (which may include text) for the second story page (step 751), orienting the image on the second story page in diametric contraposition to the first story page (step 752), and generating indicia for assembling the second story page in diametric contraposition to the first story page (step 753). Steps 730, 740, and 750 may be repeated until all story pages (including a set of first story pages and a set of second story pages) are generated. The user prints the generated pages (step 760) and assembles the pages into a storytelling book (step 770).

It will be understood that the above-described embodiments are merely illustrative of the principles of the invention and that other arrangements may be devised by those skilled in the art without departing from the spirit and scope of the invention.

1. A system for producing a storytelling book having a first set of one or more pages in diametric contraposition to a second set of one or more pages, comprising:
a software program having subroutines for
accepting input from a user:
generating a first set of one or more pages from said input; and
generating a second set of one or more pages from said input,
wherein said second set of pages are to be oriented in diametric contraposition to said first set of pages.

2. The system of claim 1 wherein said first set of pages corresponds to figures and text input by said user, and said second set of pages is automatically generated by said software program based on said first set of pages.

3. The system of claim 1 wherein said second set of pages includes a subset of the information included in said first set of pages.

4. The system of claim 1 wherein said first set of pages includes text and figures, and said second set of pages includes figures corresponding to said figures included on said first set of pages, and said second set of pages does not include text corresponding to said text included on said first set of pages.

5. The system of claim 1 wherein said software program further comprises a subroutine for automatically displaying at least one page from said first set of pages and a second page from said second set of pages in diametric contraposition to each other.

6. The system of claim 1 wherein said software program further comprises:
a subroutine for automatically generating first indicia on one or more of said pages, said first indicia indicating how to place leaves containing said first and second sets of pages in diametric contraposition to each other.

7. The system of claim 6 wherein said first indicia include binding instructions.

8. The system of claim 6 wherein said first indicia include page numbers.

9. The system of claim 6 wherein said first indicia include graphical symbols.

10. The system of claim 6 wherein said first indicia correspond to second indicia on leaves of a blank book.

11. A method for producing a storytelling book having a first set of one or more pages in diametric contraposition to a second set of one or more pages, comprising:
operating a software program;
providing input from a user to said software program;
generating, using said software program, a first set of one or more pages from said input; and
generating a second set of one or more pages from said input to be placed in diametric contraposition to said first set of pages.

12. The method of claim 1 further comprising:
generating said first set of pages corresponding to figures and text input by said user, and automatically generating said second set of pages based on said first set of pages.

13. The method of claim 1 wherein said second set of pages includes a subset of the information included in said first set of pages.

14. The method of claim 11 further comprising automatically displaying at least one page from said first set of pages and a second page from said second set of pages in diametric contraposition to each other.

15. The method of claim 1 further comprising automatically generating first indicia on one or more of said pages, said first indicia indicating how to place leaves containing said pages in diametric contraposition to each other.

16. The method of claim 15 wherein said first indicia include binding instructions.

17. The method of claim 15 wherein said first indicia include graphical symbols.

18. The method of claim 15 wherein said first indicia correspond to second indicia on the leaves of a blank book for insertion of leaves containing said first and second sets of pages.

19. A kit for producing a storytelling book having a first set of one or more pages in diametric contraposition to a second set of one or more pages, comprising:
a software program for generating said first and second sets of pages from user input; and
a blank book for insertion of said first and second sets of pages.

20. The kit of claim 19 wherein:
said software program further comprises a subroutine for automatically generating first indicia on one or more of said pages, said first indicia indicating how to place leaves containing said pages in diametric contraposition to each other; and
said first indicia correspond to second indicia on leaves of said blank book.
